(19) United States
(12) Patent Application Publication
(10) Pub. No.: US 2026/0320896 A1
(43) Pub. Date: Oct. 15, 2026

(54) VIDEO GENERATION METHOD, ELECTRONIC DEVICE, AND COMPUTER-READABLE MEDIUM

(71) Applicant: Beijing Zitiao Network Technology Co., Ltd., Beijing (CN)

(72) Inventors: Jie WU, Beijing (CN); Weifeng CHEN, Beijing (CN); Xuefeng XIAO, Beijing (CN)

(21) Appl. No.: 19/483,929

(22) PCT Filed: Apr. 29, 2024
(86) PCT No.: PCT/CN2024/090563

§ 371 Date: Nov. 12, 2025

(30) Foreign Application Priority Data
May 12, 2023 (CN) 202310539974.6

(51) Int. Cl. G06T 13/80; G06F 40/30; G06N 3/08; G06T 7/13; G06T 7/50; G06T 7/70

(52) U.S. Cl. CPC G06T 13/80; G06F 40/30; G06N 3/08; G06T 7/13; G06T 7/50; G06T 7/70; G06T 2207/10016; G06T 2207/20081

(57) ABSTRACT

The present disclosure provides a video generation method, an electronic device, and a computer-readable medium. The method includes: after obtaining a reference video and constraint text, first performing structural information extraction processing on each reference image in the reference video to obtain structural information corresponding to each reference image, such that the structural information can represent a pixel distribution state carried by the reference image; and then generating a target video based on the structural information and the constraint text, such that the target video complies to the constraint text, and structural information of each frame data in the target video remains consistent with structural information of a corresponding frame of reference image in the reference video.

This application claims the priority to and benefits of the Chinese Patent Application, No. 202310539974.6, which was filed on May 12, 2023. All the aforementioned patent applications are hereby incorporated by reference in their entireties.

### TECHNICAL FIELD

Embodiments of the present disclosure relate to a video generation method and apparatus, an electronic device, and a computer-readable medium.

### BACKGROUND

In some application scenarios, it may be necessary to generate a video based on some constraint information (for example, text like “A robot is playing basketball”), such that the video complies to the constraint information.

However, how to satisfy the needs is a technical problem that needs to be solved urgently.

### SUMMARY

The present disclosure provides a video generation method and apparatus, an electronic device, and a computer-readable medium, which can satisfy the video generation needs.

To achieve the aforementioned objective, the present disclosure provides the following technical solutions.

The present disclosure provides a video generation method. The method includes:
obtaining a reference video and constraint text, the reference video including at least two frames of reference images;
performing structural information extraction processing on each reference image to obtain structural information corresponding to each reference image; and
generating a target video based on the structural information and the constraint text.

In a possible implementation, the at least two frames of reference images include a guide image and an image to be processed, where a temporal arrangement position of the guide image corresponding to the reference video is prior to a temporal arrangement position of the image to be processed corresponding to the reference video; and
a process of generating the target video includes:
determining image representation data of a first frame in the target video based on the constraint text, structural information corresponding to the guide image, and noise data corresponding to the guide image; and
generating the target video based on the constraint text, the structural information corresponding to the at least two frames of reference images, the image representation data of the first frame, and noise data corresponding to the image to be processed.

In a possible implementation, the generating the target video based on the constraint text, the structural information corresponding to the at least two frames of reference images, the image representation data of the first frame, and noise data corresponding to the image to be processed includes: performing text feature extraction processing on the constraint text to obtain text representation data; determining structural representation data based on the structural information corresponding to the at least two frames of reference images; and generating the target video based on the text representation data, the structural representation data, the image representation data of the first frame, and the noise data corresponding to the image to be processed.

In a possible implementation, a process of determining the structural representation data includes:
inputting the structural information corresponding to the at least two frames of reference images into a structural feature extraction model that is pre-constructed to obtain the structural representation data output by the structural feature extraction model;
or
the process of determining the structural representation data includes:
concatenating the at least two frames of reference images and the structural information corresponding to the at least two frames of reference images to obtain the structural representation data.

In a possible implementation, the at least two frames of reference images include M image groups, where M is a positive integer; and
the generating the target video based on the constraint text, the structural information corresponding to the at least two frames of reference images, the image representation data of the first frame, and noise data corresponding to the image to be processed, includes:
initializing m to 1, and initializing image constraint representation data by using the image representation data of the first frame, where m is a positive integer and 1≤m≤M;
determining image representation data of an m^{th} group of video images in the target video based on the constraint text, structural information corresponding to an m^{th} image group, the image constraint representation data, and noise data corresponding to a non-first frame in the m^{th} image group;
updating the image constraint representation data by using image representation data, among the image representation data of the m^{th} group of the video images, that satisfies a preset screening condition, updating m, and continuing to execute a step of determining the image representation data of the m^{th} group of video images in the target video based on the constraint text, the structural information corresponding to the m^{th} image group, the image constraint representation data, and the noise data corresponding to the non-first frame in the m^{th} image group; and
determining the target video after the M image groups are all traversed, where the target video is determined based on the image representation data of the video images.

In a possible implementation, the image representation data of the first frame is determined by using a first generator; and
the target video is generated using a second generator, where
the first generator and the second generator are determined based on a same generator.

In a possible implementation, a process of determining the noise data corresponding to the image to be processed includes:
generating a random noise; and
performing correction processing on the random noise by using noise data corresponding to a preceding frame of the image to be processed to obtain the noise data corresponding to the image to be processed, such that part of data in the noise data corresponding to the image to be processed remains consistent with part of data in the noise data corresponding to the preceding frame.

In a possible implementation, the correction processing further includes:
determining a non-motion state representation position based on a difference between the image to be processed and the preceding frame; and
updating a value of the non-motion state representation position in the random noise by using a value of the non-motion state representation position in the noise data corresponding to the preceding frame to obtain the noise data corresponding to the image to be processed, such that a value of the non-motion state representation position in the noise data corresponding to the image to be processed remains consistent with the value of the non-motion state representation position in the noise data corresponding to the preceding frame.

In a possible implementation, the target video is generated using a generator that is pre-constructed; and
a process of constructing the generator includes:
obtaining a training video and text information corresponding to the training video, the training video including at least two frames of training images;
performing structural information extraction processing on each training image to obtain structural information corresponding to each training image; and
training the generator by using the text information corresponding to the training video and the structural information corresponding to each training image.

In a possible implementation, the training video includes N frames of training images, where N is a positive integer; and
a process of training the generator includes:
encoding each training image to obtain an encoding result of each training image;
performing noise addition processing on an encoding result of an i^{th} frame of the training images to obtain a noise-added result of the i^{th} frame of the training images, where i is a positive integer and 2≤i≤N;
determining prediction information by using the generator, the text information corresponding to the training video, the structural information corresponding to each training image, an encoding result of a 1st frame of the training images, and a noise-added result of a 2^{nd} frame of the training images to a noise-added result of an Nth frame of the training images; and
updating the generator based on the prediction information, and continuing to execute a step of determining the prediction information by using the generator, the text information corresponding to the training video, the structural information corresponding to each training image, the encoding result of the 1st frame of the training images, and the noise-added result of the 2^{nd} frame of the training images to the noise-added result of the Nth frame of the training images, until a preset stopping condition is met.

In a possible implementation, a process of determining the text information corresponding to the training video includes:
performing text extraction processing on a 1^{st} frame of the training images in the training video to obtain the text information corresponding to the training video.

In a possible implementation, the structural information is a depth map, an edge map, or an attitude map.

In a possible implementation, a process of obtaining the constraint text includes:
obtaining constraint description data, the constraint description data being image data, video data, or audio data; and
performing text extraction processing on the constraint description data to obtain the constraint text.

The present disclosure provides a video generation apparatus, including:
an obtaining unit, configured to obtain a reference video and constraint text, the reference video including at least two frames of reference images;
an extraction unit, configured to perform structural information extraction processing on each reference image to obtain structural information corresponding to each reference image; and
a generation unit, configured to generate a target video based on the structural information and the constraint text.

The present disclosure provides an electronic device. The electronic device includes: a processor and a memory, where
the memory is configured to store instructions or a computer program; and
the processor is configured to execute the instructions or computer program in the memory to cause the electronic device to execute the video generation method provided by the present disclosure.

The present disclosure further provides a computer-readable medium having instructions or a computer program stored therein which, when run on a device, cause the device to execute the video generation method provided by the present disclosure.

The present disclosure provides a computer program product, which includes a computer program carried on a non-transitory computer-readable medium, where the computer program includes program code for executing the video generation method provided by the present disclosure.

### BRIEF DESCRIPTION OF DRAWINGS

In order to describe the technical solutions in the embodiments of the present disclosure more clearly, the drawings needed by the embodiments are briefly described below. Apparently, the drawings in the following description are merely some embodiments recited in the present disclosure, and persons of ordinary skill in the art may still derive other drawings from these drawings without creative efforts.

FIG. 1 is a flowchart of a video generation method according to embodiments of the present disclosure;

FIG. 2 is a schematic diagram of a video generation process according to embodiments of the present disclosure;

FIG. 3 is a structural schematic diagram of a video generation apparatus according to embodiments of the present disclosure; and

FIG. 4 is a structural schematic diagram of an electronic device according to embodiments of the present disclosure.

### DETAILED DESCRIPTION

Through research, it has been found that some video generation solutions typically generate videos directly based on pre-set constraint information. It can be seen that these video generation solutions generate videos from scratch, such that structural information of the videos generated by using these video generation solutions is uncontrollable. As a result, the videos generated by using these video generation solutions may have a flickering problem, which leads to a poor video generation effect.

To better improve the video generation effect, the present disclosure provides a video generation method. The method includes: after obtaining a reference video (for example, a video that requires editing) and constraint text (for example, the text “A robot is playing basketball”), first performing structural information extraction processing on each reference image in the reference video to obtain structural information corresponding to each reference image, such that the structural information may represent a pixel distribution state carried by the reference image (for example, which pixels are used to describe the background, and which pixels are used to describe foreground objects); and then generating a target video based on the structural information and the constraint text, such that the target video complies to the constraint text, and structural information of each frame of image data in the target video remains consistent with structural information of a corresponding frame of reference image in the reference video (for example, structural information of a 1^{st} frame of image data in the target video remains consistent with structural information of a 1^{st} frame of reference image in the reference video). This enables video generation processing based on the constraint text and under structure constraints carried by the reference video, such that adverse effects (for example, the flickering problem) caused by an uncontrollable structure of the generated video data can be effectively avoided, thereby effectively improving the video generation effect.

Moreover, the present disclosure does not limit the executing body for the video generation method. For example, the video generation method according to the embodiments of the present disclosure may be applied to a device having a data processing function, such as a terminal device or a server. For another example, the video generation method according to the embodiments of the present disclosure may also be implemented by means of different devices (for example, a terminal device and a server, two terminal devices, or two servers). Herein, the terminal device may be a smartphone, a computer, a personal digital assistant (PDA) or a tablet. The server may be a stand-alone server, a cluster server, or a cloud server.

In order for persons skilled in the art to better understand the solutions of the present disclosure, the technical solutions in the embodiments of the present disclosure will be described below clearly and completely with reference to the drawings in the embodiments of the present disclosure. Apparently, the embodiments described are merely some rather than all of the embodiments of the present disclosure. All other embodiments obtained by those of ordinary skill in the art based on the embodiments of the present disclosure without any creative efforts shall fall within the scope of protection of the present disclosure.

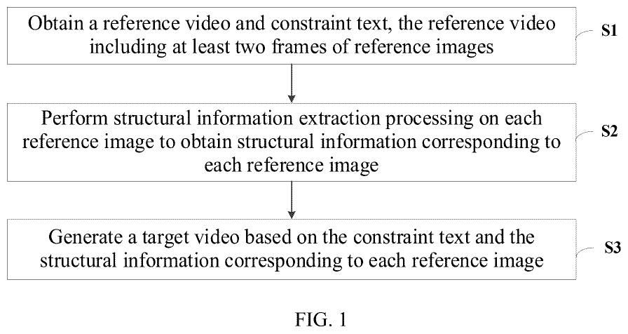

For a better understanding of the technical solution provided by the present disclosure, the video generation method according to the present disclosure is described below in conjunction with some drawings. As shown in FIG. 1, a video generation method according to embodiments of the present disclosure includes the following steps S1 to S3. Herein, FIG. 1 is a flowchart of a video generation method according to embodiments of the present disclosure.

S1: Obtain a reference video and constraint text, the reference video including at least two frames of reference images.

Herein, the reference video refers to video data that requires referring to when generating a new video, and the reference video may be used to provide structure constraints for a process of generating the new video, such that a structure state of each frame of image data in the finally generated new video remains consistent with a structure state of corresponding frame of image data in the reference video.

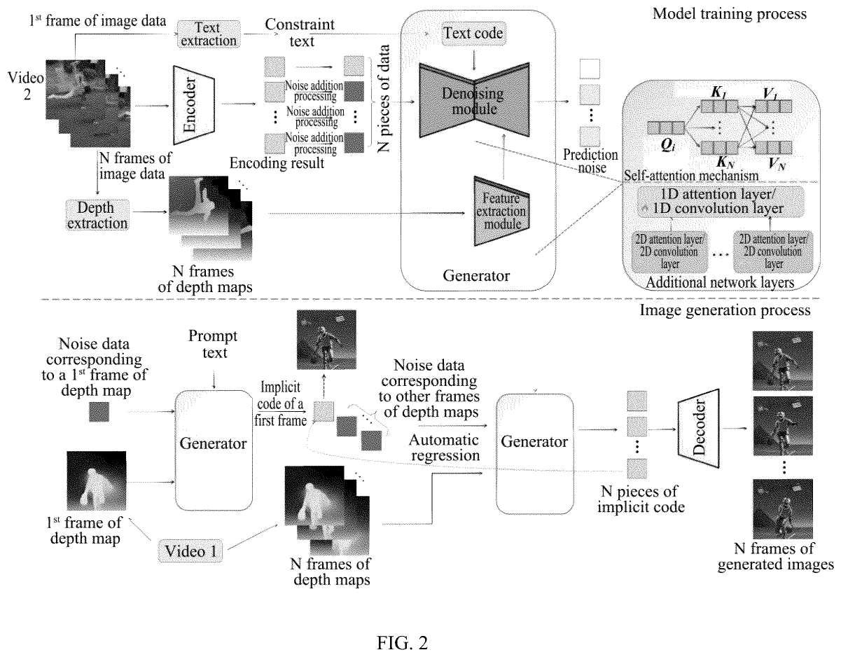

Moreover, the present disclosure does not limit the implementation of the reference video. For example, in some application scenarios (for example, a scenario of editing an existing video), the reference video may refer to video data that requires editing. For another example, in other scenarios, the reference video may refer to video data that is selected based on video generation needs by a user and used to provide structure constraints. For yet another example, the reference video may refer to video 1 as shown in FIG. 2.

In addition, for the reference video, the reference video includes at least two frames of reference images. Herein, the reference images refer to image data that is present in the reference video. Furthermore, the present disclosure does not limit a number of the reference images.

The constraint text refers to text information (for example, text information “A robot is playing basketball”) that requires referring to when a new video is being generated, and the constraint text is used to describe, by a character string, constraint information that is set for the process of generating the new video, such that the finally generated new video can comply to the constraint text.

Moreover, the present disclosure does not limit the implementation of the constraint text. For example, in some application scenarios, the constraint text may refer to constraint information (for example, prompt text shown in FIG. 2) that is set by a user for a process of generating a new video and is expressed in the form of a character string.

Through research, it is found that most other types of data (for example, image data, video data, and audio data) other than text data may be expressed by means of text data. Based on this, the present disclosure further provides a possible implementation of a process of obtaining the constraint text. In this implementation, the process of obtaining the constraint text may specifically include the following steps 1 to 2.

Step 1: First, obtain constraint description data.

Herein, the constraint description data is used to describe video generation constraints in a specific data format, where the data format is not a text data format. Moreover, the present disclosure does not limit the implementation of the constraint description data, which may be, for example, any other type of data other than text data. For ease of understanding, three cases are illustrated below as examples.

Case 1: In some application scenarios (for example, generating video data in a specific style), it may be necessary to express constraint information (for example, style constraints) configured for a new video by means of image data. Based on this, it can be seen that, in a possible implementation, the constraint description data may be implemented by using image data, such that the constraint description data may describe the constraint information in an image data format.

Case 2: In some other application scenarios, it may be necessary to express constraint information configured for a new video by means of video data. Based on this, it can be seen that, in a possible implementation, the constraint description data may be implemented by using video data, such that the constraint description data may describe the constraint information in a video data format.

Case 3: In still other scenarios, it may be necessary to express constraint information configured for a new video by means of audio data (for example, user voice data). Based on this, it can be seen that, in a possible implementation, the constraint description data may be implemented by using audio data, such that the constraint description data may describe the constraint information in an audio data format.

Step 2: Perform text extraction processing on the constraint description data to obtain constraint text.

Herein, the text extraction processing is used to extract text data from the constraint description data, such that the text data may describe, by a character string, constraint information carried by the constraint description data.

Moreover, the present disclosure does not limit the implementation of the “text extraction processing”. For example, when the constraint description data is image data, the “text extraction processing” may be implemented by using any known or future method that may convert a piece of image data into text data, such as a BLIP (Bootstrapping Language-Image Pre-training) model. For another example, when the constraint description data is video data, the “text extraction processing” may be implemented using any known or future method that may convert a piece of video data into text data. For still another example, when the constraint description data is audio data, the “text extraction processing” may be implemented using any known or future method that may convert a piece of audio data into text data.

Based on the relevant content of the steps 1 and 2, in some application scenarios, the constraint text may be determined by performing text extraction processing on constraint description data. This enables effective enriching of expression methods of the constraint information, thereby being beneficial to enriching application scenarios of the video generation method provided by the present disclosure.

Based on the relevant content of the S1, it can be seen that under some application scenarios (such as a scenario of editing an existing video), when a new video is to be generated, a reference video and constraint text need to be obtained at first, such that the reference video and the constraint text are both used to describe constraint conditions required in a video generation process, thereby subsequently completing the generation of the new video under the constraints of the reference video and the constraint text.

S2: Perform structural information extraction processing on each reference image to obtain structural information corresponding to each reference image.

Herein, structural information corresponding to a reference image is used to describe a structure state of the reference image (for example, which pixels are used to describe the background, and which pixels are used to describe foreground objects).

Moreover, the present disclosure does not limit the implementation of the structural information, which may be implemented, for example, using any known or future data information (for example, a depth map shown in FIG. 2) that may describe a structure state of a piece of image data. For ease of understanding, three cases are illustrated below as examples.

Case 1: In some application scenarios, a structure state of a piece of image data may be described by means of a depth map. Based on this, it can be seen that in a possible implementation, the structural information may be implemented by using a depth map (for example, a depth map shown in FIG. 2).

Case 2: In other scenarios, a structure state of a piece of image data may be described by means of an edge map. Based on this, it can be seen that in a possible implementation, the structural information may be implemented by using an edge map.

Case 3: In still other application scenarios, a structure state of a piece of image data may be described by means of an attitude map. Based on this, it can be seen that in a possible implementation, the structural information may be implemented by using an attitude map.

The “structural information extraction processing” is used to extract structural information from a piece of image data. Furthermore, the present disclosure does not limit the implementation of the “structural information extraction processing”. For example, when the structural information is implemented by using a depth map, the “structural information extraction processing” may implemented by using any known or future method that may perform depth extraction processing on a piece of image data (for example, a depth extraction method shown in FIG. 2). For another example, when the structural information is implemented by using an edge map, the “structural information extraction processing” may be implemented by using any known or future method that may perform edge extraction processing on a piece of image data. For still another example, when the structural information is implemented by using an attitude map, the “structural information extraction processing” may be implemented by using any known or future method that may perform attitude extraction processing on a piece of image data.

Based on the relevant content of the S2, it can be seen that after a reference video (for example, video 1 shown in FIG. 2) is obtained, structural information extraction processing (for example, depth extraction processing) may be performed on each frame of the reference images in the reference video to obtain structural information corresponding to each reference image (for example, N frames of depth maps shown in FIG. 2), such that these structural information may represent structural constraints carried by the reference video, and thus a new video that complies with the structure constraints (for example, a new video including N frames of generated images shown in FIG. 2) may be subsequently generated based on these structural information, where N is a positive integer.

S3: Generate a target video based on the constraint text and the structural information corresponding to each reference image.

Herein, the target video refers to a finally generated new video (for example, a new video including N frames of generated images shown in FIG. 2).

Moreover, a number of frames of image data in the target video is the same as a number of frames of reference images in the “at least two frames of reference images”. For example, when the reference video includes N frames of reference images, the target video also includes N frames of image data.

In addition, structural information of each frame of image data in the target video remains consistent with structural information of a corresponding frame of reference image in the reference video. That is, structural information of a 1^{st} frame of image data in the target video remains consistent with structural information of a 1st frame of reference image in the reference video; structural information of a 2^{nd} frame of image data in the target video remains consistent with structural information of a 2^{nd} frame of reference image in the reference video; structural information of a 3^{rd} frame of image data in the target video remains consistent with structural information of a 3^{rd} frame of reference image in the reference video; (and so on); and structural information of an N^{th} frame of image data in the target video remains consistent with structural information of an N^{th} frame of reference image in the reference video. Herein, the “consistent” refers to that the similarity between two pieces of data is relatively high (for example, the similarity reaches a preset similarity threshold, or the two are exactly the same).

Furthermore, the target video satisfies the constraint text. For example, when the constraint text is “A robot is playing basketball”, the target video is used to describe a motion process of a robot playing basketball. For another example, when the constraint text defines a specific image style (for example, the constraint text is extracted from image data of a specific style), each frame of image data in the target video belongs to this style, such that stylized processing for a piece of video data may be subsequently implemented based on the constraint text and the video generation method provided by the present disclosure.

Moreover, the present disclosure does not limit the implementation of the S3, which may be implemented, for example, using any known or future method that may generate a piece of video data based on constraint text and structural information corresponding to each reference image (for example, implemented by means of a pre-constructed machine learning model that may generate a piece of video data based on constraint text and structural information corresponding to each reference image).

It can be seen that in a possible implementation, the S3 may specifically be as follows: inputting the constraint text and the structural information corresponding to each reference image into a machine learning model that is pre-constructed to obtain a target video output by the machine learning model, such that the target video satisfies the constraint text, and the structural information of each frame of image data in the target video remains consistent with structural information of a corresponding frame of reference image in the reference video. It should be noted that the present disclosure does not limit the implementation of the machine learning model. For example, the machine learning model may be implemented by using a generator based on a diffusion model. Moreover, the present disclosure does not limit a process of constructing the machine learning model either.

Based on the relevant content of the S1 to S3, for the video generation method provided by the embodiments of the present disclosure, after a reference video (such as a video that requires editing) and constraint text (such as “A robot is playing basketball”) are obtained, structural information extraction processing is first performed on each reference image in the reference video to obtain structural information corresponding to each reference image, such that the structural information can express a pixel distribution state carried by the reference image (for example, which pixels are used to describe the background, and which pixels are used to describe foreground objects); and then generating a target video based on the structural information and the constraint text, such that the target video satisfies the constraint text, and structural information of each frame of image data in the target video remains consistent with structural information of a corresponding frame of reference image in the reference video (for example, structural information of a 1^{st} frame of image data in the target video remains consistent with structural information of a 1^{st} frame of reference image in the reference video). This enables video generation processing based on the constraint text and under structure constraints carried by the reference video, such that adverse effects (for example, the flickering problem) caused by an uncontrollable structure of the generated video data can be effectively avoided, thereby effectively improving the video generation effect.

In practice, in order to better improve the video generation effect, a process of generating all frames of image data in a new video may be guided by using a first frame in the new video as a constraint condition. Based on this, the present disclosure further provides a possible implementation of the S3. In this implementation, when the at least two frames of reference images include a guide image (for example, a 1st frame of reference image) and an image to be processed (for example, another reference image other than the 1^{st} frame of reference image), and a temporal arrangement position of the guide image corresponding to the reference video is prior to a temporal arrangement position of the image to be processed corresponding to the reference video, the S3 may specifically include the following steps 11 and 12.

Step 11: determine image representation data of a first frame in the target video based on the constraint text, structural information corresponding to the guide image, and noise data corresponding to the guide image.

Herein, the guide image refers to the reference image that is present in the reference video, and used to guide a process of generating a non-first frame in the target video.

Moreover, the present disclosure does not limit the guide image, which may refer to, for example, a first frame of reference image that is present in the reference video.

The “noise data corresponding to the guide image” refers to noise data that requires referring to when determining the first frame in the target video. For example, the “noise data corresponding to the guide image” may refer to “noise data corresponding to a 1^{st} frame of depth map” shown in FIG. 2.

Moreover, the present disclosure does not limit the implementation of the “noise image corresponding to the guide image”, which may refer to, for example, randomly generated noise data.

The “image representation data of a first frame in a target video” is used to represent a 1^{st} frame of image data in the target video. Furthermore, the present disclosure does not limit the implementation of the “image representation data of a first frame in a target video”, which may be implemented, for example, using implicit code (for example, “implicit code of the first frame” shown in FIG. 2).

In addition, the present disclosure does not limit the implementation of the step 11, which may be implemented, for example, using any known or future method that may generate image representation data (for example, implicit code) of a new image based on a piece of text information, structural information corresponding to a piece of image data, and noise data corresponding to the image data.

For another example, in some application scenarios, the step 11 may specifically be as follows: inputting the constraint text, structural information corresponding to the guide image, and noise data corresponding to the guide image into a first generator that is pre-constructed, to obtain image representation data of a first frame in a target video output by the first generator.

Herein, the first generator is used to generate image representation data (for example, implicit code) of a new image based on a piece of text information, structural information corresponding to a piece of image data, and noise data corresponding to the image data. Furthermore, the present disclosure does not limit the implementation of the first generator. For example, the first generator may be implemented by using any known or future image generator. For another example, the first generator may be implement by using a generator constructed by the following steps 41 to 43. For still another example, the first generator may be implemented by using the generator shown in FIG. 2.

In practice, in a possible implementation, the step 11 may also be implemented by using the following steps 111 to 113.

Step 111: Perform text feature extraction processing on the constraint text to obtain text representation data, such that the text representation data is used to represent semantic information carried by the constraint text.

It should be noted that the present disclosure does not limit the implementation of the step 111, which may be implemented, for example, by using any known or future method that may perform text feature extraction processing on a piece of text data (such as a contrastive language-image pre-training (CLIP) model).

Step 112: determine structural representation data corresponding to the guide image based on structural information corresponding to the guide image, such that the structural representation data may represent a structure state of the guide image.

It should be noted that the present disclosure does not limit the implementation of the step 112. For ease of understanding, the description is made below in conjunction with three examples.

Example 1: in a possible implementation, the step 112 may specifically be as follows: directly determining structural information corresponding to the guide image as structural representation data corresponding to the guide image.

Example 2: in another possible implementation, the step 112 may specifically be as follows: inputting structural information corresponding to the guide image into a structural feature extraction model that is pre-constructed to obtain structural representation data corresponding to the guide image output by the structural feature extraction model.

Herein, the structural feature extraction model is used to perform feature extraction processing on structural information. Furthermore, the present disclosure does not limit the implementation of the structural feature extraction model. For example, the structural feature extraction model may be implemented using any know or future method that may perform feature extraction processing on structural information (for example, an encoding network or a feature extraction module as shown in FIG. 2). For another example, in some application scenarios, for the structural feature extraction model, when there are two-dimensional (2D) convolutional layers and/or 2D attention layers in the structural feature extraction model, a 1D convolutional layer may be added after each 2D convolutional layer, and a ID temporal attention layer (similar to a module with a flame in FIG. 2) may be added after each 2D attention layer, to extend the function of the structural feature extraction model from an image processing function to a video processing function, such that the structural feature extraction model after function expansion may be used to perform feature extraction processing on structural information corresponding to at least one piece of image data.

Moreover, the present disclosure does not limit a construction process of the structural feature extraction model, which may be implemented, for example, by using any known or future model construction method. For another example, in some application scenarios, when the structural feature extraction model is included in the generator (for example, the generator shown in FIG. 2) constructed by the following steps 41 to 43, the structural feature extraction model may be constructed according to a process shown in the following steps 41 to 43.

Example 3: in still another possible implementation, the step 112 may specifically be as follows: concatenating the guide image and structural information corresponding to the guide image to obtain structural representation data corresponding to the guide image, such that the structural representation data may better represent a structure state of the guide image.

Step 113: determine image representation data of a first frame in the target video based on the text representation data, the structural representation data corresponding to the guide image, and noise data corresponding to the guide image.

It should be noted that the present disclosure does not limit the implementation of step 113, which may be implemented, for example, using any known or future method that may implement the step 113. For ease of understanding, the description is made below in conjunction with examples.

As an example, in a possible implementation, the step 113 may specifically be as follows: inputting the text representation data, the structural representation data corresponding to the guide image, and noise data corresponding to the guide image are input to a denoising module that is pre-constructed, to obtain the “image representation data of a first frame in a target video” output by the denoising module.

It should be noted that the present disclosure does not limit the implementation of the denoising module, which may be implemented, for example, using a denoising module in any known or future diffusion model. For another example, in some application scenarios, the denoising module may be implemented using a denoising module in the generator constructed by the following steps 41 to 43.

Based on the relevant content of the steps 111 to 113, in some application scenarios, the image representation data of the first frame in the target video may be generated by means of the generator shown in FIG. 2, such that the image representation data may subsequently better guide a process of generating all frames of image data in the target video.

Step 12: Generate the target video based on the constraint text, structural information corresponding to the at least two frames of reference images, the image representation data of the first frame, and noise data corresponding to the image to be processed.

Herein, the image to be processed refers to a reference image that is present in the reference video, and used to generate a non-first frame in the target video.

Moreover, the present disclosure does not limit the image to be processed, which may refer to, for example, another reference image that is present in the reference video other than a first frame of reference image.

The noise data corresponding to the image to be processed refers to noise data that requires referring to when determining the non-first frame in the target video.

Moreover, the present disclosure does not limit the implementation of the “noise data corresponding to the image to be processed”, which may refer to, for example, randomly generated noise data.

Through research, it is found that in some application scenarios (for example, when video generation processing is performed by using a denoising module in a diffusion model), the video generation effect is not only related to predetermined constraint information (for example, constraint text), but also affected by noise data. That is, when the constraint information is fixed, different noise data may produce completely different video generation results. It can be seen that, in order to better improve the video generation effect, some constraints (for example, for noise data corresponding to two adjacent frames, noise values corresponding to pixels used to represent a non-motion state should remain consistent) may be imposed on the noise data.

Based on the content in the preceding paragraph, the present disclosure further provides a possible implementation of a process of determining the “noise data corresponding to the image to be processed”. In this implementation, for any image to be processed, a process of determining the noise data corresponding to the image to be processed may specifically include the following steps 21 and 22.

Step 21: generate a random noise (that is, randomly generated noise data).

It should be noted that the present disclosure does not limit the implementation of step 21.

Step 22: perform correction processing on the random noise by using noise data corresponding to a preceding frame of the image to be processed to obtain the noise data corresponding to the image to be processed, such that part of data in the noise data corresponding to the image to be processed remains consistent with part of data in noise data corresponding to the preceding frame.

Herein, the preceding frame of the image to be processed refers to a reference image that is present in the reference video and whose temporal arrangement position is prior to and adjacent to a temporal arrangement position of the image to be processed. For example, when the image to be processed refers to an h^{th} frame of reference image in the reference video, a preceding frame of the image to be processed refers to an (h−1)^{th} frame of reference image in the reference video, where h is a positive integer and h−1≥1.

Moreover, the present disclosure does not limit the implementation of the step 22, which may specifically include, for example, the following steps 221 and 222.

Step 221: determine a non-motion state representation position based on a difference between the image to be processed and the preceding frame of the image to be processed.

Herein, the non-motion state representation position refers to the position of a pixel point where pixel values of two adjacent frames of images are the same or less changed, such that the non-motion state representation position may represent the pixel point that is present in the image to be processed relative to the preceding frame of the image to be processed and used to represent a non-motion state.

Moreover, the present disclosure does not limit a process of determining the non-motion state representation position, which may specifically be, for example: first, making a difference between an image to be processed and a preceding frame of the image to be processed; then determining whether a difference value corresponding to each pixel point is less than a preset threshold, and if the difference value is less than the preset threshold value, determining that the pixel value of the pixel point is hardly unchanged, such that the position of the pixel point may be determined as a non-motion state representation position; and if the difference value is not less than the preset threshold, determining that the pixel value of the pixel point is changed significantly, such that the position of the pixel point may be determined as a motion state representation position. Herein, the non-motion state representation position refers to the position of a pixel point where pixel values of two adjacent frames of images are changed significantly, such that the non-motion state representation position may represent the pixel point that is present in the image to be processed relative to the preceding frame of the image to be processed and used to represent a motion state.

Step 222: update a value of the non-motion state representation position in the random noise by using a value of the non-motion state representation position in the noise data corresponding to the preceding frame of the image to be processed to obtain the noise data corresponding to the image to be processed, such that a value of the non-motion state representation position in the noise data corresponding to the image to be processed remains consistent with the value of the non-motion state representation position in the noise data corresponding to the preceding frame.

In the present disclosure, after the non-motion state representation position is determined from the difference between the image to be processed and the preceding frame of the image to be processed, the value of the non-motion state representation position in the random noise may be directly replaced with the value of the corresponding non-motion state representation position in the noise data corresponding to the preceding frame, to obtain the noise data corresponding to the image to be processed, such that the value of the non-motion state representation position in the noise data corresponding to the image to be processed remains consistent with the value of the corresponding non-motion state representation position in the noise data corresponding to the preceding frame. This can guarantee that noise values corresponding to pixel points between adjacent frames, that is used to represent the non-motion state, remains consistent, but pixel points used to represent the motion state correspond to different noise values, such that the noise data corresponding to the adjacent frames satisfies some constraints between the adjacent frames (for example, non-motion state constraints). This contributes to improving the smoothness of a video, thereby reducing the occurrence of video flickering, and then improving the video production effect.

Based on the relevant content of the steps 21 to 22, it can be seen that in some application scenarios, when the reference video includes N frames of reference images, for a 1^{st} frame of reference image, randomly generated noise data 1 may be directly determined as noise data corresponding to the 1^{st} frame of reference image (that is, the “noise data corresponding to the guide image”). For a 2^{nd} frame of reference image, after a non-motion state representation position and a motion state representation position of the 2^{nd} frame of reference image relatively to the 1^{st} frame of reference image are determined, and randomly generated noise data 2 is determined, a value at each non-motion state representation position in the noise data 2 may be directly replaced with a value at a corresponding position in the noise data 1, and keeping a value at each motion state representation position in the noise data 2 unchanged, to obtain noise data corresponding to the 2^{nd} frame of reference image; . . . (and so on), thereby contributing to improving the smoothness of generated video data.

It can be seen from the content in the preceding paragraph that for any image to be processed, it can be ensured that values at some positions in noise data corresponding to the image to be processed remain consistent with values at corresponding positions in noise data corresponding to a preceding frame of the image to be processed, such that the purpose of constraining the noise data may be achieved, thereby contributing to improving the video production effect.

Moreover, the present disclosure does not limit the implementation of the step 12. For ease of understanding, the description is made below in conjunction with some possible implementations.

In a possible implementation, the step 12 may specifically be as follows: first, inputting the constraint text, structural information corresponding to the at least two frames of reference images, the image representation data of the first frame, and noise data corresponding to the image to be processed into a second generator that is pre-constructed (for example, the generator shown in FIG. 2), to obtain image representation data (for example, N implicit codes shown in FIG. 2) of each frame of image data in a target video output by the second generator; and then, determining a target video based on the image representation data of these image data (for example, separately decoding the image representation data of each piece of image data to obtain each piece of image data, and generating the target video based on these image data).

Herein, the second generator is used to generate image representation data (for example, implicit code) of all image data in a new video based on one piece of text information, structural information corresponding to a plurality of pieces of image data, image representation data of a first frame of image data among the plurality of pieces of image data, and noise data corresponding to non-first frame of image data of these image data. Furthermore, the present disclosure does not limit the implementation of the second generator, which may be implemented, for example, using any known or future video generator. For another example, the second generator may be implemented using the generator shown in FIG. 2.

Moreover, the present disclosure does not limit the association between the second generator and the first generator, which both may be, for example, different generators. For still another example, in a possible implementation, the second generator and the first generator are determined based on a same generator (for example, the generator shown in FIG. 2), such that the second generator is the same as the first generator, better coordination is achieved between the step 11 implemented based on the first generator and the step 12 implemented based on the second generator, and thus the “image representation data of a first frame in a target video” determined based on the first generator may better guide a process of generating all frames of image data in the target video, thereby contributing to improving the video generation effect.

In practice, in a possible implementation, the step 12 may specifically include the following steps 121 to 123.

Step 121: perform text feature extraction processing on the constraint text to obtain text representation data, such that the text representation data is used to represent semantic information carried by the constraint text.

It should be noted that, for the relevant content of step 121, please refer to the step 111, which will not be repeated here for the sake of brevity.

Step 122: determine structural representation data based on the structural information corresponding to the at least two frames of reference images, such that the structural representation data may represent a structure state of these reference images.

It should be noted that the present disclosure does not limit the implementation of the step 122. For example, the implementation of the step 122 is similar to the implementation of the step 112, which will not be repeated here for the sake of brevity. For ease of understanding, the description is made below in conjunction with two examples.

Example 1: in a possible implementation, the step 122 may specifically be as follows: inputting structural information corresponding to the at least two frames of reference images into a structural feature extraction model that is pre-constructed to obtain structural representation data output by the structural feature extraction model, such that the structural representation data may represent structure states of these reference images. It should be noted that, for the relevant content of the structural feature extraction model, please refer to the content, which will not be repeated here for the sake of brevity.

Example 2: in another possible implementation, the step 122 may specifically be as follows: concatenating the at least two frames of reference images and structural information corresponding to the at least two frames of reference images to obtain structural representation data, such that the structural representation data can better represent structure states of these reference images.

It should be noted that the present disclosure does not limit the implementation of concatenation processing in the preceding paragraph, which may specifically be, for example: concatenating each frame of reference image and structural information corresponding to the frame of reference image to obtain structural representation data, such that the structural representation data includes a concatenated result corresponding to each frame of reference image. Herein, the concatenated result corresponding to one frame of reference image is obtained by concatenating the reference image with the structural information corresponding to the reference image.

It can be seen from the relevant content of the step 122 that after obtaining the structural information corresponding to the at least two frames of reference images, structural representation data corresponding to these reference images may be determined based on the structural information, such that the structural representation data may represent structure states of these reference images.

Step 123: generate a target video based on the text representation data, the structural representation data, the image representation data of the first frame, and noise data corresponding to an image to be processed.

It should be noted that the present disclosure does not limit the implementation of step 123 which may be implemented, for example, using any known or future method that may implement step 123. For ease of understanding, the description is made below in conjunction with examples.

As an example, in a possible implementation, the step 123 may specifically be as follows: inputting the text representation data, the structural representation data, the image representation data of the first frame, and noise data corresponding to an image to be processed into a denoising module that is pre-constructed, to obtain image representation data (for example, N implicit codes shown in FIG. 2) of each frame of image data in a target video output by the denoising module; and then determining a target video based on the image representation data of these image data (for example, separately decoding the N implicit codes shown in FIG. 2 to obtain N frames of generated images, and determining the target video based on these generated images).

It should be noted that the present disclosure does not limit the association between the denoising module in the preceding paragraph and a denoising module involved in the step 113, which both may be implemented, for example, using different denoising modules. For another example, in some applications, the two may be implemented by using the same denoising module.

It can be seen that in some application scenarios, when the denoising module involved in the step 123 and the denoising module involved in the step 113 are implemented using a same denoising module, the denoising module may have an image generation function and a video generation function. Therefore, in order to ensure the processing performance of the denoising module, some improvements may be made for specific denoising modules (especially denoising modules with the image generation function), and these improvements are specifically as follows: (1) Some learnable temporal parameters are added after a 2D convolutional layer and/or a 2D attention layer in the denoising module, that is, a 1D convolutional layer is added after each 2D convolutional layer and/or a 1D temporal attention layer is added after each 2D attention layer (that is, a module with a frame in FIG. 2), to extend a processing function of the denoising module, such as from an image generation function to a video generation function, such that the denoising module may process at least one frame of image data, and thus the denoising module may uniformly implement an image/video generation process. (2) The present disclosure provides a space-time based attention mechanism (for example, a self-attention mechanism shown in FIG. 2) for the 1D temporal attention layer, and the space-time based attention mechanism is specifically as follows: Qi (Query) corresponding to an i^{th} frame of image data performs attention processing on Ki (Key) and Vi (Value) corresponding to each frame of image data among the N frame of image data (i=1, . . . , N), and fine-grained modeling is performed on different frames of the video, thereby enhancing the consistency between video frames.

Based on the relevant content of the steps 121 to 123, it can be seen that in some application scenarios, the target video may be generated by means of the generator shown in FIG. 2, such that the target video satisfies not only constraint information carried by the reference video, but also constraint information carried by the constraint text.

Based on the relevant content of the steps 11 and 12, it can be seen that in some application scenarios, the image representation data (for example, implicit code of the first frame shown in FIG. 2) of the first frame in the target video may be generated at first based on a 1st frame of reference image in the reference video; and then under the guidance of the image representation data of the first frame, all image data in the target video is determined, such that the first frame in the new video may be used as a constraint condition to guide a process of generating all frames of image data in the new video, which is beneficial to improving the video generation effect.

In practice, in some application scenarios, a process of generating a video of any length (especially a relatively long video) may be realized by iteratively generating a plurality of video segments (for example, an automatic regression manner shown in FIG. 2). Based on this, the present disclosure further provides a possible implementation of the S3. In this implementation, when the at least two frames of reference images include M picture groups, where M is a positive integer, and a 1^{st} image group includes the guide image, the S3 may specifically include the following steps 31 to 36.

Step 31: determine image representation data of a first frame in a target video based on the constraint text, structural information corresponding to the guide image (that is, a 1^{st} frame of image data in the 1^{st} image group), and the noise data corresponding to the guide image.

It should be noted that, for the relevant content of step 31, please refer to the step 11, which will not be repeated here for the sake of brevity.

Step 32: Initialize m to 1 and initialize image constraint representation data using the image representation data of the first frame, where m is a positive integer, 1≤m≤M.

Herein, an image group is used to represent all reference images involved in a video segment generation process.

Moreover, the present disclosure does not limit the implementation of the M picture groups. For example, when the reference video includes G frame of reference images, where G is a positive integer, and G=1+M×(J−1), a 1^{st} frame of reference image to a J^{th} frame of reference image may be grouped into a 1^{st} image group, such that the 1^{st} image group may be subjected to video segment generation processing under the guidance of a generated image corresponding to the 1^{st} frame of reference image; the J^{th} frame of reference image to a (2J−1)^{th} frame of reference image are grouped into a 2^{nd} image group, such that the 2^{nd} image group may be subjected to video segment generation processing under the guidance of a generated image corresponding to the J^{th} reference image; . . . (and so on). Herein, J is a positive integer, and the present disclosure does not limit the J. For example, J=N shown in FIG. 2.

It should be noted that the present disclosure does not limit a grouping rule of the M image groups. For example, the grouping rule may be set according to the actual application scenario.

m is used to represent a serial number of an image group that needs to be used in a current video segment generation process. Furthermore, an initial value of m is 1, that is, during a 1^{st} video segment generation process, a new video segment needs to be generated based on the 1^{st} image group.

The image constraint representation data refers to image guidance information (for example, implicit code) that needs to be based on during a current video segment generation process (that is, when generating a new video segment based on an m^{th} image group). For example, when m=1, the image constraint representation data is the “image representation data of a first frame in a target video”, that is, the 1^{st} video segment generation process is implemented under the guidance of the “image representation data of a first image in a target video”.

Step 33: determine image representation data of an m^{th} video image group in a target video based on the constraint text, structural information corresponding to an m^{th} image group, the image constraint representation data, and noise data corresponding to a non-first frame in the m^{th} image group.

Herein, the structural information corresponding to the m^{th} image group includes structural information corresponding to all reference images in the m^{th} image group, such that the “structural information corresponding to an m^{th} image group” is used to represent structure states of all the reference images in the m^{th} image group.

The non-first frame in the m^{th} image group is another reference image that is present in the m^{th} image group other than the reference image with the foremost temporal arrangement position. For example, when the m^{th} image group includes a 1^{st} frame of reference image to a J^{th} frame of reference image, a 2^{nd} frame of reference image, a 3^{rd} frame of reference image, . . . , and the J^{th} frame of reference image may be regarded as non-first frame in the m^{th} image group.

The m^{th} video image group is used to represent all image data in a new video segment generated based on the m^{th} image group.

The image representation data of the m^{th} video image group is used to represent image information carried by all image data in the new video segment generated based on the m^{th} image group.

It should be noted that the present disclosure does not limit the implementation of the step 33. For example, the implementation of the step 33 is similar to any implementation of the step 12, which will not be repeated here for the sake of brevity.

Step 34: determine whether the M image groups are all traversed, and when yes, execute the following step 36; and when no, execute the following step 35.

Step 35: in response to being determined that the M image groups are not all traversed, update the image constraint representation data using image representation data, among the image representation data of the m^{th} group of video images, that satisfies a preset screening condition, update m, and return to continue executing the step 33 and its subsequent steps.

Herein, the preset screening condition is used to screen out image guide information (for example. implicit code) that needs to be used in a next video segment generation process. Furthermore, the present disclosure does not limit the preset screening condition. For example, the screening condition may be set according to the application scenario. For ease of understanding, the description is made below in conjunction with examples.

As an example, when a 1^{st} image group includes a 1^{st} frame of reference image to a J^{th} frame of reference image, a 2^{nd} image group includes a J^{th} frame of reference image to a (2J−1)^{th} frame of reference image, . . . (and so on), the preset screening condition may specifically be: image representation data with the rearmost arrangement position in the image representation data of the m^{th} video image group (that is, image representation data of a last frame of video image in the m^{th} video image group).

Moreover, the present disclosure does not limit the implementation of the step “update the image constraint representation data using image representation data, among the image representation data of the m^{th} group of video images, that satisfies a preset screening condition”, which may specifically be, for example: determining image representation data, among the image representation data of the m^{th} video image group, that satisfies a preset screening condition, as new image constraint representation data.

In addition, the present disclosure does not limit the implementation of “update m” in the preceding paragraph, which may be implemented, for example, using the following formula (1).

$${M}^{′} = m + 1 \qquad ( 1 )$$

where m′ represents an updated m value.

Based on the relevant content of the step 35, for the current video segment generation process, in response to determining that the image representation data of the M video image groups are not obtained, it may be determined that there are still some image groups are not traversed. Therefore, image representation data of the last frame of video image may be extracted from the image representation data of the m^{th} video image group, the image constraint representation data may be updated with the image representation data of the last frame of video image, such that the updated image constraint representation data is the image representation data of the last frame of video image. Moreover, m also needs to be updated, such that the step 33 and its subsequent steps can be subsequently executed once again based on the updated image constraint representation data and the updated m. this can start the next video segment generation process.

Step 36: determine the target video in response to determining that the M image groups are all traversed, where the target video is determined based on the image representation data of the video images.

It should be noted that the present disclosure does not limit the implementation of the step “determine a target video” described in the preceding paragraph. For example, when image representation data at the rearmost arrangement position in image representation data of a d^{th} group of video images and image representation data at the foremost arrangement position in image representation data of a (d+1)^{th} group of video images are both used to represent the same video image, where d is a positive integer and d≤M−1, image representation data at the rearmost arrangement position in image representation data of a 1^{st} video image group may be removed first, image representation data at the rearmost arrangement position in image representation data of a 2^{nd} video image group may be removed, . . . (and so on), image representation data at the rearmost arrangement position in image representation data of an (M−1)^{th} video image group may be removed. Then, the image representation data of the M groups of video images are sequentially concatenated to obtain an image representation data sequence. Finally, the image representation data sequence is decoded to obtain a target video.

For another example, when image representation data at the rearmost arrangement position in image representation data of a d^{th} group of video images and image representation data at the foremost arrangement position in image representation data of a (d+1)th group of video images are both used to represent the same video image, where d is a positive integer and d≤M−1, after image representation data of an m^{th} group of video images is obtained, the image representation data of the d^{th} group of video images is decoded to obtain an m^{th} image sequence, where 1≤m≤M. Then, image data at the rearmost arrangement position in a 1^{st} image sequence is removed, image data at the rearmost arrangement position in a 2^{nd} image sequence is removed, . . . (and so on), image data at the rearmost arrangement position in an (M−1)^{th} image sequence is removed. Finally, the M image sequences are sequentially concatenated to obtain a target video.

Based on the relevant content of the steps 31 to 36, it can be seen that in some application scenarios (for example, scenarios requiring the generation of long videos), the process of generating long videos may be completed by iteratively generating video segments (for example, generating longer videos in an autoregressive manner as shown in FIG. 2). This can effectively avoid and overcome the difficulties of generating long videos, thereby contributing to improving the video generation effect.

In practice, in some application scenarios, a process of generating the target video may be implemented by means of a generator that is pre-constructed (for example, the generator shown in FIG. 2). Based on this, the present disclosure further provides a process of constructing the generator, which may specifically include the following steps 41 to 43.

Step 41: obtain a training video and text information corresponding to the training video, the training video including at least two frames of training images.

The training video refers to video data that needs to be used when constructing a generator; Furthermore, the present disclosure does not limit the training video, which may be, for example, video 2 shown in FIG. 2. Moreover, the present disclosure does not limit a number of the training videos.

The training images refer to image data that is present in the training video. Furthermore, the present disclosure does not limit a number of the training images.

The text information corresponding to the training video is used to describe the content of the training video. Furthermore, the present disclosure does not limit a process of determining the “text information corresponding to the training video”, which may be implemented, for example, by manual labeling.

In practice, in order to reduce the training difficulty, the present disclosure further provides a possible implementation of a process of obtaining the “text information corresponding to the training video”, which may specifically be as follows: performing text extraction processing on a 1^{st} frame of training image in the training video to obtain text information corresponding to the training video. It should be noted that the present disclosure does not limit the implementation of the text extraction processing, which may be implemented, for example, using BLIP.

Step 42: perform structural information extraction processing on each training image to obtain structural information corresponding to each training image.

Herein, the structural information corresponding to a training image is used to describe a structure state of the training image (for example, which pixels are used to describe the background, and which pixels are used to describe foreground objects).

It should be noted that the relevant content of the “structural information corresponding to the training image” is similar to the relevant content of the “structural information corresponding to the reference image”, which will not be repeated here for the sake of brevity.

Step 43: train a video generator by using the text information corresponding to the training video and the structural information corresponding to each training image.

It should be noted that the present disclosure does not limit the implementation of the step 43, which may be implemented, for example, using any known or future model training method (for example, a diffusion model training method).

Through research, it is found that a training task may affect the process of training the generator, such that in order to better reduce the training difficulty, the task of “generating a new video using a first frame of image data in a piece of specific video data as a condition” may be used as a training task that needs to be completed in a construction process of the generator. Based on this, the present disclosure further provides a possible implementation of the step 43. In this implementation, when the training video includes N frames of training images, where N is a positive integer, the step 43 may specifically include the following steps 431 to 434.

Step 431: encode each training image to obtain an encoding result of each training image.

Herein, an encoding result of an n^{th} training image is used to represent image information carried by the n^{th} training image, where n is a positive integer, n≤N.

Moreover, the present disclosure does not limit a process of determining the “encoding result of an n^{th} training image”, which may be implemented, for example, using any known or future encoding manner (for example, any encoder, an encoder in a diffusion model, or an encoder shown in FIG. 2).

Step 432: perform a noise addition processing on an encoding result of an i^{th} frame of training image to obtain a noise-added result of the i^{th} frame of training image, where i is a positive integer, and 2≤i≤N.

Herein, the noise-added result of the i^{th} frame of training image is determined by performing noise addition processing on the encoding result of the i^{th} training image.

Moreover, the present disclosure does not limit a determination manner of the “noise-added result of the i^{th} frame training image”, which may be implemented, for example, using any known or future noise addition method (for example, a noise addition module in a diffusion model or a noise addition manner shown in FIG. 2).

Step 433: determine prediction information by using a generator, the text information corresponding to the training video, the structural information corresponding to each training image, an encoding result of a 1^{st} frame of training image, and noise-added results of a 2^{nd} frame of training image to an N^{th} frame of training image.

Herein, the prediction information refers to prediction information determined by means of a generator after the text information corresponding to the training video, the structural information corresponding to each training image, the encoding result of the 1^{st} frame of training image, and the noise-added results of the 2^{nd} frame of training image to the N^{th} frame of training image are input into the generator.

Moreover, the present disclosure does not limit the prediction information. For example, in some application scenarios, the prediction information may include N prediction noises (for example, prediction noises shown in FIG. 2), such that the prediction performance of the generator may be subsequently determined based on a degree of similarity between the prediction noise and actually added noise. For another example, in some other application scenarios, the prediction information may include N pieces of generated image data, such that the prediction performance of the generator may be subsequently determined based on these generated image data.

Step 434: determine whether a preset stopping condition is met, and when yes, end a training process; and when no, update the generator based on the prediction information and return and continue to execute the step 433 and its subsequent steps.

Herein, the preset stopping condition refers to a condition that needs to be met at the end of the process of training the generator. Furthermore, the preset disclosure does not limit the preset stopping condition, which may specifically be, for example, as follows: a loss of the generator is lower than a first threshold, or a loss change rate of the generator is lower than a second threshold (that is, the generator reaches convergence), or a number of updates of the generator reaches a third threshold.

It should be noted that the “loss of the generator” in the preceding paragraph is used to describe the prediction performance of the generator. Furthermore, the present does not limit a process of determining the “loss of the generator”, which may be implemented, for example, using any known or future method that can measure the prediction performance of the generator (for example, a loss function of a diffusion model).

It should be further noted that the present disclosure does not limit the implementation of the step “update the generator based on the prediction information”, which may be set based on the actual application scenario.

Based on the relevant content of the steps 431 to 434, it can be seen that in some application scenarios, the task of “generating a new video using a first frame of image data in a piece of specific video data as a condition” may be used as a training task that needs to be completed in a construction process of the generator. In this way, only a small amount of training data is needed for the generator to learn how to generate video data. Moreover, in some application scenarios, a plurality of first frames may also be used as indication information to achieve autoregressive generation of longer videos, no longer limited to video generation at a time. For example, 8 frames are generated for the first time, and in order to generate a longer continuous video, an 8th frame may be used as the beginning of next 8 frames, such that a video of 8+8 frames can be generated. It can be seen that by using this method, infinitely long videos can be generated theoretically, no longer limited to generation at a time, thereby contributing to better improving the video production effect.

Based on the relevant content of the steps 41 to 43, it can be seen that in some application scenarios, for the construction process of the generator, as shown in FIG. 2, a depth map of each training image in a training video may be extracted, each training image in the training data is sequentially encoded, and noise addition processing is performed on encoding results of other training images in the training video other than a first frame of training image, such that the generator may complete the training task of “generating a new video using a first frame of image data in a piece of specific video data as a condition” based on these information, and thus the constructed generator may derive all frames of images in a new video based on information such as a first frame, constraint text, and depth map in any video.

It should be noted that in order to better improve the construction effect of the generator, the present disclosure may combine a plurality of pieces of image data and a plurality of pieces of video data complete the construction process of the generator, such that the constructed generator has both image generation function and video generation function. Furthermore, in the construction process, when a number of frames is 1, it may be determined that training data is the image data, noise may be directly added to the training data, and the generator may be trained using the training data added with the noise. When a number of frames is greater than 1, it may be determined that training data is the video data, and the generator may be trained in a manner shown in FIG. 2.

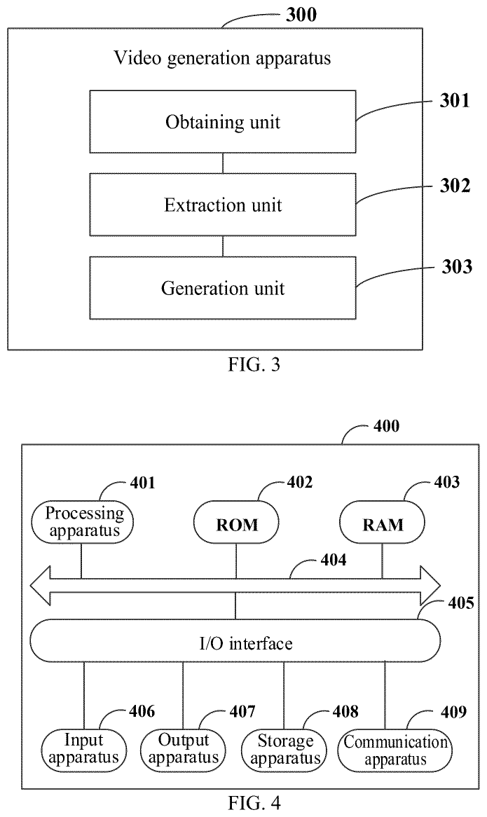

Based on the video generation method according to the embodiments of the present disclosure, embodiments of the present disclosure further provide a video generation apparatus, which is explained and described below with reference to FIG. 3. FIG. 3 is a structural schematic diagram of a video generation apparatus according to embodiments of the present disclosure. It should be noted that, for the technical details of the video generation apparatus according to the embodiments of the present disclosure, reference may be made to the relevant content of the aforementioned video generation method.

As shown in FIG. 3, a video generation apparatus 300 according to embodiments of the present disclosure includes:
an obtaining unit 301, configured to obtain a reference video and constraint text, the reference video including at least two frames of reference images;
an extraction unit 302, configured to perform structural information extraction processing on each reference image to obtain structural information corresponding to each reference image; and
a generation unit 303, configured to generate a target video based on the structural information and the constraint text.

In a possible implementation, the at least two frames of reference images include a guide image and an image to be processed, where a temporal arrangement position of the guide image corresponding to the reference video is prior to a temporal arrangement position of the image to be processed corresponding to the reference video; and
the generation unit 303 includes:
a first determination sub-unit, configured to determine image representation data of a first frame in the target video based on the constraint text, structural information corresponding to the guide image, and noise data corresponding to the guide image; and
a first generation subunit, configured to generate the target video based on the constraint text, the structural information corresponding to the at least two frames of reference images, the image representation data of the first frame, and noise data corresponding to the image to be processed.

In a possible implementation, the first generation sub-unit includes:
a first extraction sub-unit, configured to perform text feature extraction processing on the constraint text to obtain text representation data;
a second determination subunit, configured to determine structural representation data based on the structural information corresponding to the at least two frames of reference images; and
a second generation subunit, configured to generate the target video based on the text representation data, the structural representation data, the image representation data of the first frame, and the noise data corresponding to the image to be processed.

In a possible implementation, the second determination sub-unit is specifically configured to: input the structural information corresponding to the at least two frames of reference images into a structural feature extraction model that is pre-constructed to obtain the structural representation data output by the structural feature extraction model

In a possible implementation, the second determination sub-unit is specifically configured to: concatenate the at least two frames of reference images and the structural information corresponding to the at least two frames of reference images to obtain the structural representation data.

In a possible implementation, the at least two frames of reference images include M image groups, where M is a positive integer; and the first generation sub-unit is specifically configured to: initialize m to 1, and initializing image constraint representation data by using the image representation data of the first frame, where m is a positive integer and 1≤m≤M; determine image representation data of an m^{th} group of video images in the target video based on the constraint text, structural information corresponding to an m^{th} image group, the image constraint representation data, and noise data corresponding to a non-first frame in the m^{th} image group; update the image constraint representation data by using image representation data, among the image representation data of the m^{th} group of the video images, that satisfies a preset screening condition, updating m, and continuing to execute a step of determining the image representation data of the m^{th} group of video images in the target video based on the constraint text, the structural information corresponding to the m^{th} image group, the image constraint representation data, and the noise data corresponding to the non-first frame in the m^{th} image group; and determine the target video after the M image groups are all traversed, where the target video is determined based on the image representation data of the video images.

In a possible implementation, the image representation data of the first frame is determined by using a first generator; and the target video is generated by using a second generator, where the first generator and the second generator are determined based on a same generator.

In a possible implementation, the video generation apparatus 300 further includes:
a noise generation unit, configured to generate a random noise; and
a noise correction unit, configured to perform correction processing on the random noise by using noise data corresponding to a preceding frame of the image to be processed to obtain the noise data corresponding to the image to be processed, such that part of data in the noise data corresponding to the image to be processed remains consistent with part of data in the noise data corresponding to the preceding frame.

In a possible implementation, the noise correction unit is specifically configured to:
determine a non-motion state representation position based on a difference between the image to be processed and the preceding frame; and update a value of the non-motion state representation position in the random noise by using a value of the non-motion state representation position in the noise data corresponding to the preceding frame to obtain the noise data corresponding to the image to be processed, such that a value of the non-motion state representation position in the noise data corresponding to the image to be processed remains consistent with the value of the non-motion state representation position in the noise data corresponding to the preceding frame.

In a possible implementation, the target video is generated using a generator that is pre-constructed; and a process of constructing the generator includes:
obtaining a training video and text information corresponding to the training video, the training video including at least two frames of training images;
performing structural information extraction processing on each training image to obtain structural information corresponding to each training image; and
training the generator by using the text information corresponding to the training video and the structural information corresponding to each training image.

In a possible implementation, the training video includes N frames of training images, where N is a positive integer; and
a process of training the generator includes:
encoding each training image to obtain an encoding result of each training image;
performing noise addition processing on an encoding result of an i^{th} frame of the training images to obtain a noise-added result of the i^{th} frame of the training images, where i is a positive integer and 2≤i≤N;
determining prediction information by using the generator, the text information corresponding to the training video, the structural information corresponding to each training image, an encoding result of a 1^{st} frame of the training images, and a noise-added result of a 2^{nd} frame of the training images to a noise-added result of an Nth frame of the training images; and
updating the generator based on the prediction information, and continuing to execute a step of determining the prediction information by using the generator, the text information corresponding to the training video, the structural information corresponding to each training image, the encoding result of the 1^{st} frame of the training images, and the noise-added result of the 2^{nd} frame of the training images to the noise-added result of the Nth frame of the training images, until a preset stopping condition is met.

In a possible implementation, a process of determining the text information corresponding to the training video includes: performing text extraction processing on a 1^{st} frame of the training images in the training video to obtain the text information corresponding to the training video.

In a possible implementation, the structural information is a depth map, or an edge map, or an attitude map.

In a possible implementation, the obtaining unit 301 includes:
a data obtaining sub-unit, configured to obtain constraint description data, the constraint description data being image data, video data, or audio data; and
a text extraction sub-unit, configured to perform text extraction processing on the constraint description data to obtain the constraint text.

Based on the relevant content of the video generation apparatus 300, for the video generation apparatus 300 according to the embodiment of the present disclosure, after a reference video (such as a video that requires editing) and constraint text (such as “A robot is playing basketball”) are obtained, structural information extraction processing is first performed on each reference image in the reference video to obtain structural information corresponding to each reference image, such that the structural information can express a pixel distribution state carried by the reference image (for example, which pixels are used to describe the background, and which pixels are used to describe foreground objects). and then generating a target video based on the structural information and the constraint text, such that the target video satisfies the constraint text, and structural information of each frame of image data in the target video remains consistent with structural information of a corresponding frame of reference image in the reference video (for example, structural information of a 1^{st} frame of image data in the target video remains consistent with structural information of a 1^{st} frame of reference image in the reference video). This enables video generation processing based on the constraint text and under structure constraints carried by the reference video, such that adverse effects (for example, the flickering problem) caused by an uncontrollable structure of the generated video data can be effectively avoided, thereby effectively improving the video generation effect.

Moreover, embodiments of the present disclosure further provide an electronic device. The device includes a processor and a memory; the memory is configured to store instructions or a computer program; and the processor is configured to execute the instructions or computer program in the memory to enable the electronic device to perform any implementation of the video generation method according to the embodiments of the present disclosure.

Reference is made to FIG. 4, which is a schematic diagram of a structure of an electronic device 400 suitable for implementing embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (for example, a vehicle navigation terminal), and fixed terminals such as a digital TV and a desktop computer. The electronic device shown in FIG. 4 is merely an example, and shall not impose any limitation on the function and scope of use of the embodiments of the present disclosure.

As shown in FIG. 4, the electronic device 400 may include a processing apparatus (for example, a central processing unit or a graphics processing unit) 401 that may perform a variety of appropriate actions and processing in accordance with a program stored in a read-only memory (ROM) 402 or a program loaded from a storage apparatus 408 into a random access memory (RAM) 403. The RAM 403 further stores various programs and data required for operations of the electronic device 400. The processing apparatus 401, the ROM 402, and the RAM 403 are connected to each other through a bus 404. An input/output (I/O) interface 405 is also connected to the bus 404.

Generally, the following apparatuses may be connected to the I/O interface 405: an input apparatus 406 including, for example, a touchscreen, a touchpad, a keyboard, a mouse, a camera, a microphone, an accelerometer, and a gyroscope; an output apparatus 407 including, for example, a liquid crystal display (LCD), a speaker, and a vibrator; the storage apparatus 408 including, for example, a tape and a hard disk; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all of the shown apparatuses. It may be an alternative to implement or have more or fewer apparatuses.

In particular, according to embodiments of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 409, installed from the storage apparatus 408, or installed from the ROM 402. When the computer program is executed by the processing apparatus 401, the above functions defined in the method of the embodiment of the present disclosure are performed.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

Embodiments of the present disclosure also provide a computer-readable medium having instructions or a computer program stored therein which, when run on a device, cause the device to perform any implementation of the video generation method provided by embodiments of the present disclosure.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, enable the electronic device to perform the above method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under specific circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “include”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments shown herein, but extends to the widest scope that complies with the principles and novelty disclosed in this specification.

1. A video generation method, comprising:
obtaining a reference video and constraint text, the reference video comprising at least two frames of reference images;
performing structural information extraction processing on each reference image to obtain structural information corresponding to each reference image; and
generating a target video based on the structural information and the constraint text.

2. The method according to claim 1, wherein the at least two frames of reference images comprise a guide image and an image to be processed, wherein a temporal arrangement position of the guide image corresponding to the reference video is prior to a temporal arrangement position of the image to be processed corresponding to the reference video; and
a process of generating the target video comprises:
determining image representation data of a first frame in the target video based on the constraint text, structural information corresponding to the guide image, and noise data corresponding to the guide image; and
generating the target video based on the constraint text, the structural information corresponding to the at least two frames of reference images, the image representation data of the first frame, and noise data corresponding to the image to be processed.

3. The method according to claim 2, wherein the generating the target video based on the constraint text, the structural information corresponding to the at least two frames of reference images, the image representation data of the first frame, and noise data corresponding to the image to be processed comprises:
performing text feature extraction processing on the constraint text to obtain text representation data;
determining structural representation data based on the structural information corresponding to the at least two frames of reference images; and
generating the target video based on the text representation data, the structural representation data, the image representation data of the first frame, and the noise data corresponding to the image to be processed.

4. The method according to claim 3, wherein a process of determining the structural representation data comprises:
inputting the structural information corresponding to the at least two frames of reference images into a structural feature extraction model that is pre-constructed to obtain the structural representation data output by the structural feature extraction model;
or
the process of determining the structural representation data comprises:
concatenating the at least two frames of reference images and the structural information corresponding to the at least two frames of reference images to obtain the structural representation data.

5. The method according to claim 2, wherein the at least two frames of reference images comprise M image groups, where M is a positive integer; and
the generating the target video based on the constraint text, the structural information corresponding to the at least two frames of reference images, the image representation data of the first frame, and noise data corresponding to the image to be processed, comprises:
initializing m to 1, and initializing image constraint representation data by using the image representation data of the first frame, where m is a positive integer and 1≤m≤M;
determining image representation data of an m^{th} group of video images in the target video based on the constraint text, structural information corresponding to an m^{th} image group, the image constraint representation data, and noise data corresponding to a non-first frame in the m^{th} image group;
updating the image constraint representation data by using image representation data, among the image representation data of the m^{th} group of the video images, that satisfies a preset screening condition, updating m, and continuing to execute a step of determining the image representation data of the m^{th} group of video images in the target video based on the constraint text, the structural information corresponding to the m^{th} image group, the image constraint representation data, and the noise data corresponding to the non-first frame in the m^{th} image group; and
determining the target video after the M image groups are all traversed, wherein the target video is determined based on the image representation data of the video images.

6. The method according to claim 2, wherein the image representation data of the first frame is determined by using a first generator;
the target video is generated by using a second generator, and,
the first generator and the second generator are determined based on a same generator.

7. The method according to claim 2, wherein a process of determining the noise data corresponding to the image to be processed comprises:
generating a random noise; and
performing correction processing on the random noise by using noise data corresponding to a preceding frame of the image to be processed to obtain the noise data corresponding to the image to be processed, such that part of data in the noise data corresponding to the image to be processed remains consistent with part of data in the noise data corresponding to the preceding frame.

8. The method according to claim 7, wherein the correction processing comprises:
determining a non-motion state representation position based on a difference between the image to be processed and the preceding frame; and
updating a value of the non-motion state representation position in the random noise by using a value of the non-motion state representation position in the noise data corresponding to the preceding frame to obtain the noise data corresponding to the image to be processed, such that a value of the non-motion state representation position in the noise data corresponding to the image to be processed remains consistent with the value of the non-motion state representation position in the noise data corresponding to the preceding frame.

9. The method according to claim 1, wherein the target video is generated by using a generator that is pre-constructed; and
a process of constructing the generator comprises:
obtaining a training video and text information corresponding to the training video, the training video comprising at least two frames of training images;
performing structural information extraction processing on each training image to obtain structural information corresponding to each training image; and
training the generator by using the text information corresponding to the training video and the structural information corresponding to each training image.

10. The method according to claim 9, wherein the training video comprises N frames of training images, where N is a positive integer; and
a process of training the generator comprises:
encoding each training image to obtain an encoding result of each training image;
performing noise addition processing on an encoding result of an i^{th} frame of the training images to obtain a noise-added result of the i^{th} frame of the training images, where i is a positive integer and 2≤i≤N;
determining prediction information by using the generator, the text information corresponding to the training video, the structural information corresponding to each training image, an encoding result of a 1^{st} frame of the training images, and a noise-added result of a 2^{nd} frame of the training images to a noise-added result of an N^{th} frame of the training images; and
updating the generator based on the prediction information, and continuing to execute a step of determining the prediction information by using the generator, the text information corresponding to the training video, the structural information corresponding to each training image, the encoding result of the 1^{st} frame of the training images, and the noise-added result of the 2^{nd} frame of the training images to the noise-added result of the N^{th} frame of the training images, until a preset stopping condition is met.

11. The method according to claim 9, wherein a process of determining the text information corresponding to the training video comprises:
performing text extraction processing on a 1^{st} frame of the training images in the training video to obtain the text information corresponding to the training video.

12. The method according to claim 1, wherein the structural information is a depth map, an edge map, or an attitude map.

13. The method according to claim 1, wherein a process of obtaining the constraint text comprises:
obtaining constraint description data, the constraint description data being image data, video data, or audio data; and
performing text extraction processing on the constraint description data to obtain the constraint text.

14. (canceled)

15. An electronic device, comprising: at least one processor and a at least one memory, wherein
the at least one memory is configured to store instructions or a computer program; and
the at least one processor is configured to execute the instructions or computer program stored in the at least one memory to cause the electronic device to execute a video generation method, and the method comprises:
obtaining a reference video and constraint text, the reference video comprising at least two frames of reference images;
performing structural information extraction processing on each reference image to obtain structural information corresponding to each reference image; and
generating a target video based on the structural information and the constraint text.

16. A non-transitory computer-readable medium, wherein the computer-readable medium stores instructions or a computer program that, when run on a device, cause the device to execute a video generation method, and the method comprises:
obtaining a reference video and constraint text, the reference video comprising at least two frames of reference images;
performing structural information extraction processing on each reference image to obtain structural information corresponding to each reference image; and
generating a target video based on the structural information and the constraint text.

17. The electronic device according to claim 15, wherein the at least two frames of reference images comprise a guide image and an image to be processed, wherein a temporal arrangement position of the guide image corresponding to the reference video is prior to a temporal arrangement position of the image to be processed corresponding to the reference video; and
a process of generating the target video comprises:
determining image representation data of a first frame in the target video based on the constraint text, structural information corresponding to the guide image, and noise data corresponding to the guide image; and
generating the target video based on the constraint text, structural information corresponding to the at least two frames of reference images, the image representation data of the first frame, and noise data corresponding to the image to be processed.

18. The electronic device according to claim 17, wherein the generating the target video based on the constraint text, the structural information corresponding to the at least two frames of reference images, the image representation data of the first frame, and noise data corresponding to the image to be processed comprises:
performing text feature extraction processing on the constraint text to obtain text representation data;
determining structural representation data based on the structural information corresponding to the at least two frames of reference images; and
generating the target video based on the text representation data, the structural representation data, the image representation data of the first frame, and the noise data corresponding to the image to be processed.

19. The electronic device according to claim 18, wherein a process of determining the structural representation data comprises:
inputting the structural information corresponding to the at least two frames of reference images into a structural feature extraction model that is pre-constructed to obtain the structural representation data output by the structural feature extraction model;
or
the process of determining the structural representation data comprises:
concatenating the at least two frames of reference images and the structural information corresponding to the at least two frames of reference images to obtain the structural representation data.

20. The electronic device according to claim 17, wherein the at least two frames of reference images comprise M image groups, where M is a positive integer; and
the generating the target video based on the constraint text, the structural information corresponding to the at least two frames of reference images, the image representation data of the first frame, and noise data corresponding to the image to be processed, comprises:
initializing m to 1, and initializing image constraint representation data by using the image representation data of the first frame, where m is a positive integer and 1≤m≤M;
determining image representation data of an m^{th} group of video images in the target video based on the constraint text, structural information corresponding to an m^{th} image group, the image constraint representation data, and noise data corresponding to a non-first frame in the m^{th} image group;
updating the image constraint representation data by using image representation data, among the image representation data of the m^{th} group of the video images, that satisfies a preset screening condition, updating m, and continuing to execute a step of determining the image representation data of the m^{th} group of video images in the target video based on the constraint text, the structural information corresponding to the m^{th} image group, the image constraint representation data, and the noise data corresponding to the non-first frame in the m^{th} image group; and
determining the target video after the M image groups are all traversed, wherein the target video is determined based on the image representation data of the video images.

21. The electronic device according to claim 17, wherein the image representation data of the first frame is determined by using a first generator;
the target video is generated by using a second generator; and
the first generator and the second generator are determined based on a same generator.
